(19) United States
(12) Patent Application Publication
(10) Pub. No.: US 2019/0134922 A1
(43) Pub. Date: May 9, 2019

(54) METHOD OF ATTACHING CUSHION PAD TO SURFACE OF AUTOMATIVE COMPONENT ASSEMBLY FOR FRICTION AND NOISE PREVENTION

(71) Applicant: Jung Sik PARK, Cheonan-Si (KR)

(72) Inventor: Jung Sik PARK, Cheonan-Si (KR)

(21) Appl. No.: 16/184,345

(22) Filed: Nov. 8, 2018

(30) Foreign Application Priority Data
Nov. 9, 2017 (MX) 2017-014393

(51) Int. Cl. B29C 65/48; B29C 69/00

(52) U.S. Cl. CPC B29C 65/48; B29L 2031/58; B29C 69/001

(57) ABSTRACT

In order to prevent friction and noise, a method of attaching a cushion pad to a surface of an automotive component assembly is provided. In the method, a strip of the cushion pad including a plurality of individual block portions is prepared. Then, the strip of the cushion pad is applied to attach each of the plurality of the individual block portions onto the surface of the automotive component assembly while concurrently or successively removing a paper film from the strip of the cushion pad.

### CROSS-REFERENCE TO RELATED APPLICATION

Priority is claimed to Mexico Patent Application No. 2017-014393, filed on Nov. 9, 2017, the content of which is incorporated herein by reference.

### BACKGROUND OF THE INVENTION

### Field of the Invention

The present invention relates to the automotive industry in general, and in particular, to various means or elements used in a proper combination of automotive components, and especially to various types of boards and vehicle brands, and more particularly, to a method of attaching a cushion pad to a surface of an automotive component assembly to prevent friction and noise.

### Description of Related Art

In the automotive industry, it is a proper design and construction of fixtures and assembly elements in connection with an assembly of various plastic pieces, such as boards of three welds, that ensure a perfect fit and assembly which prevents movement between pieces.

However, even if fastening and assembling of elements are completed with high advanced technology, friction is generated on a contact surface at all times. Friction and noise of automotive parts are inevitable depending on conditions of traveling paths of a moving vehicle. The friction and noise can be perceived as a factor of low-quality product and thus they cause dissatisfaction to a buyer.

One way to solve this problem is to attach some pads that are cushioned and stick to or come in contact with a contact surface or a surface between the friction and noise producing automotive parts.

Some pads produced by the primary producer are wound in a cylindrical shape. The size of the cylindrically rolled pad varies, for example, from 1 m to 30 m width and from 1 m to 40 m/1 m to 50 m length. The roll pads can be machined and cut into sections of smaller rolled dimensions to create rolls that can be assembled in the machine. For this, mechanical devices or dispensers can be provided to supply one or two pads, by which an operator holds the pads with one hand and places the pads in the required area of the automotive plastic part.

These distribution machines are more commonly referred to as automatic label separating machines, label dispensers, or pads and each of them includes a peel when an end-cuff pad roll is mounted and extended so that a series of rollers and strips are wound on the bottom roll and returned by the bottom roll. These machines may include a sensing element for an automatic feed that is easy to peel off the label or pad upon its return and drives a feeder roll pulling the pad sheet from the pad roll.

With respect to this technology, a patent document, EP0017858 (A1), invented by Dr. Viennann Antonius, was filed on Apr. 2, 1980.

This document discloses a dispenser including a conveyor belt or the like having a label tape that can be transported through a transport roller to achieve a high labeling speed. A compact design supporting tape of a label dispenser, which provides a means for driving the conveying roller at a constant speed and for interlocking with the conveying roller or for securing the belt for the stepwise conveyance of the belt, is pressed against the conveying roller in a controlled manner. In this way, the support rollers have to be accelerated and braked very finely only by the continuous drive of the transport roller and the controlled pressing of the label tape. Therefore, a number of things are recorded, including whether or not very high frequency distribution labels are available.

Another patent document, GB1527893, filed on Oct. 14, 1975 and disclosed by Claude Deshayes, refers to a machine for weaving a band of a predetermined length into a strip of a short length.

In this machine, the label or indicating band unit has a pair of feed rollers and signals generated by the control circuit associated with both the tag distribution and the continuously driven pressing roller which can cause the pressure roller to come in contact with the roller. The rollers are triggered by an additional signal when the strip is out coupled through the guide in an overlapped relationship with the band. This also occurs when the feed is coupled by the narrowing of the strip roller.

When a band of a predetermined length is supplied to the band winding unit, the additional signal generated by the control circuit triggers the blade. At the trailing edge of the strip, there is an adhesive dispensed from the unit for attaching the edge of the strip to the roll.

Generally, in the relevant field, various automatic label separating machines are known, by which either the operator or the user can remove the labels or pads and attach them to the required areas of the automotive plastic parts.

Another application method can be manually performed without using the automatic release of the label or pad dispenser, and individual pads can be separated from a sheet portion having a size of 13 cm and 60 cm. However, it is slow and requires a lot of skill to manually separate each pad individually in a spreadsheet or a large section without separating the other pads.

Accordingly, the present invention has been developed for the purpose of preventing friction and noise between automotive parts, avoiding from purchasing unnecessary machines for attaching pads to automobile parts, shortening the working time, and reducing production and application costs.

### SUMMARY OF THE INVENTION

The main object of the present invention is to enable a new method of manual application of a cushion pad to a surface of an automotive component assembly in order to prevent friction and noise, which provides a high efficiency, shortens processing time and enhances working conditions. This method can shorten the manufacturing process by up to 40%, thereby increasing productivity.

Another object of the present invention is to provide a method of manual application of a cushion pad to a surface of an automotive component assembly to avoid friction and noise, which also eliminates the need to obtain a pad distributor and thus reduces application costs.

It is a further object of the present invention to increase the speed and precision of pad placement by the operator by preventing friction and noise using the above method of manually attaching the cushion pad to the surface of the automotive component assembly.

Another object of the present invention is to provide a method of manual application of a cushion pad to a surface of an automotive component assembly to avoid friction and noise, which is also simple and practical, requiring no separate training to do so.

The objects of the present invention will also be described in detail below with reference to the accompanying drawings.

According to an aspect of the present invention, the cushion pad includes a non-woven fabric layer, an adhesive layer disposed on a surface of the non-woven layer, and a paper film removably attached on a surface of the adhesive layer.

According to one embodiment of the present application, the method of attaching a cushion pad to a surface of an automotive component assembly comprises: preparing a strip of the cushion pad having a width of 1 cm to 2 cm and a length of 30 cm to 40 cm, the strip of the cushion pad including a plurality of individual block portions, each of the plurality of the individual block portions having a width of 1 cm to 2 cm and a length of 1 cm to 2 cm; holding the strip of the cushion pad by a hand of an user to apply the strip of the cushion pad to the surface of the automotive component assembly; and attaching, by a thumb of the user, each of the plurality of the individual block portions onto the surface of the automotive component assembly while concurrently and successively removing the paper film by an index finger of the user.

In some embodiments of the present invention, the step of preparing the strip of the cushion comprises: cutting a sheet of the cushion pad into a plurality of reduced sheet sections having a width of 5 cm to 20 cm, a length of 20 cm to 70 cm, and a thickness of 0.2 cm to 1 cm; preparing a die and pressing each of the plurality of the reduced sheet sections on the die to form the plurality of the individual block portions by cutting only the non-woven fabric layer and the adhesive layer without cutting the paper film; and cutting each of the plurality of the reduced cushion sheet sections into a plurality of the strips of the cushion pad, each of the plurality of the strips of the cushion pad having a vertically or horizontally elongated shape.

For a better understanding of the features of the invention, reference is made to the following description of an exemplary drawing.

### BRIEF DESCRIPTION OF THE DRAWINGS

FIG. 1A shows a cross sectional view of a cushion pad;

FIG. 1B shows a reduced sheet section of the cushion pad in FIG. 1A, the reduced sheet section having a plurality of individual block portions;

FIG. 2 shows a process of cutting the reduced sheet section in FIG. 1B into a plurality of strips of the cushion pad;

FIG. 3 shows a top view of two strips of the cushion pad;

FIGS. 4 and 5 are schematic views illustrating a method of manually applying a cushion pad to a surface of an automotive component assembly; and

FIG. 6 shows a block diagram of a process of manufacturing the strip of the cushion pad.

### DETAILED DESCRIPTION OF THE INVENTION

For a better understanding of the present invention, aspects of the present invention will be described in detail.

The drawings are attached to this document for non-limiting illustrative purposes.

The characteristic details of how to apply a cushion pad to a surface of an automotive component assembly to prevent friction and noise and how to manufacture a strip of the cushion pad for manual application are clearly shown in the following description and drawings. These and other aspects are provided so that this disclosure will be thorough and complete, and will fully convey the scope of the invention.

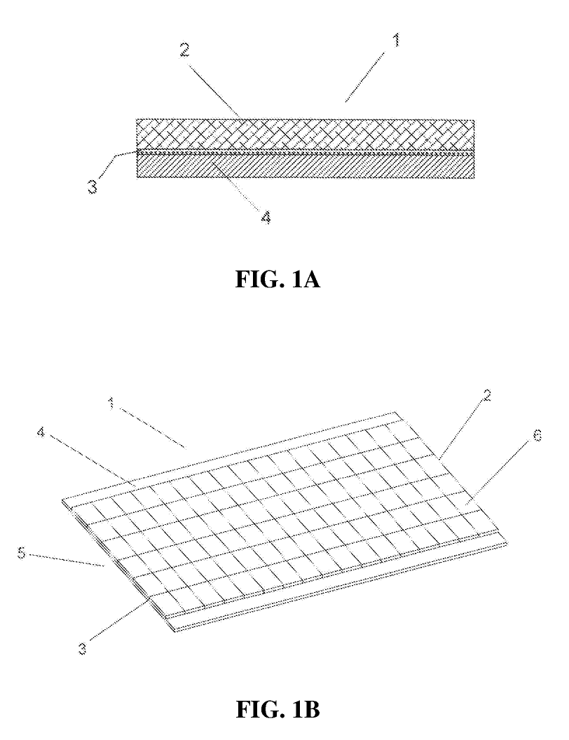

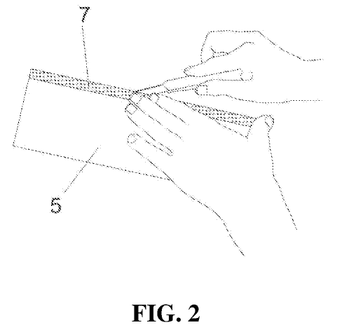

FIG. 1A shows a cross sectional view of a cushion pad. FIG. 1B shows a reduced sheet section of the cushion pad in FIG. 1A and the reduced sheet section has a plurality of individual block portions.

Referring to FIG. 1A, a cushion pad 1 is provided to be applied to a surface of an automotive component assembly to prevent friction and noise. The cushion pad 1 includes a non-woven fabric layer 2 with an adhesive layer 3 and a paper film 4 removably attached to the adhesive layer 3. The removable paper film 4 may be a double-sided tape in the form of a blank sheet which exposes an adhesive layer 3.

Referring to FIG. 1B, a sheet of the cushion pad 1 having a dimension of 1 m width, 30 to 50 m length, and 0.5 thickness is firstly prepared. This sheet of the cushion pad 1 is preferably cut into a plurality of reduced sheet sections 5, each having a dimension of 12 cm width and 30 cm to 40 cm length.

Each of the plurality of the reduced sheet sections 5 is processed by a die and a press by cutting only the non-woven fabric layer 2 and the adhesive layer 3 without cutting the paper film 4. This allows to define individual block portions 6 having a dimension of 1 cm width and 1 to 2 cm length that can be separated individually.

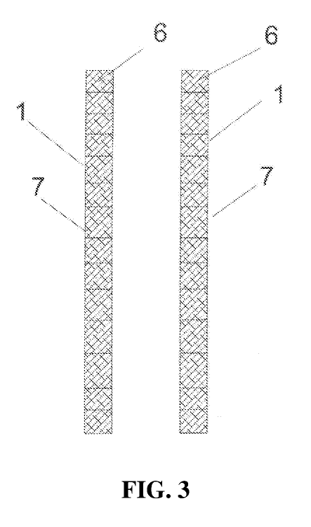

FIG. 2 shows a process of cutting the reduced sheet section in FIG. 1B into a plurality of strips of the cushion pad.

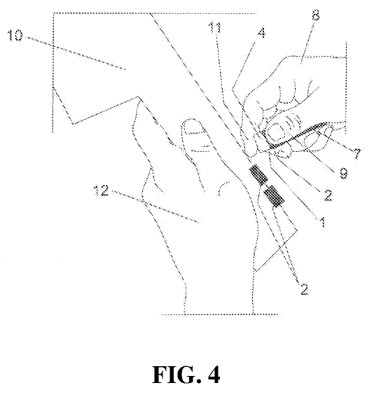

Referring to FIG. 2, it is manually performed to cut the reduced sheet section into a plurality of strips of the cushion pad (7, see FIG. 3), each having a dimension of 1 to 2 cm width and 30 to 40 cm length and having a vertically or horizontally elongated shape.

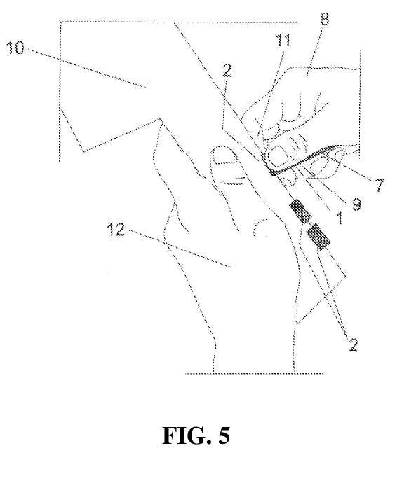

FIGS. 4 and 5 are schematic views illustrating a method of manually applying a cushion pad to a surface of an automotive component assembly.

Each strip of the cushion pad 7 having the individual block portions 6 in the drawings is manually held with one hand 8 using a thumb 9. The non-woven fabric layer 2 of the cushion pad 1 with the adhesive layer 3 is attached onto the surface of the automotive component assembly 10 while the paper film 4 is concurrently or successively removed by an index finger of the user.

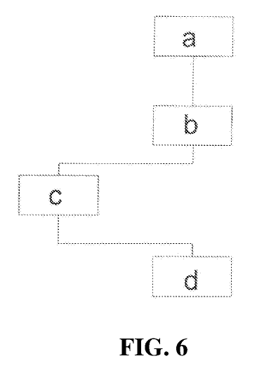

FIG. 6 shows a block diagram of a process of manufacturing the strip of the cushion pad.

Referring to FIG. 6, the sheet of the cushion pad is cut into the plurality of reduced sheet sections, each having a width of 5 cm to 20 cm, a length of 20 cm to 70 cm, and a thickness of 0.2 cm to 1 cm (step a). A dimension of a width of 13 cm, a length of 30 to 40 cm, and a thickness of 0.5 cm of each reduced sheet section is more preferred.

A die and a press can be prepared to press each of the plurality of the reduced sheet sections on the die so as to form the plurality of the individual block portions, each having a width of 1 to 2 cm and a length of 1 to 2 cm, by cutting only the non-woven fabric layer and the adhesive layer without cutting the paper film (step b).

Each of the plurality of the reduced cushion sheet sections is cut into a plurality of the strips of the cushion pad, each having a 1 to 2 cm width and 30 to 40 cm length and having a vertically or horizontally elongated shape (step c).

Each of the plurality of the strips of the cushion pad is held by a hand of a user and each of the plurality of the individual block portions is attached, by a thumb of the user, onto the surface of the automotive component assembly while the paper film is concurrently or successively removed by an index finger of the user (step d).

The present invention has been fully described so that a person of ordinary skill in the art can reproduce the results mentioned in the document relating to the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A method of attaching a cushion pad to a surface of an automotive component assembly, the cushion pad having a non-woven fabric layer, an adhesive layer disposed on a surface of the non-woven layer, and a paper film removably attached on a surface of the adhesive layer, the method comprising:
preparing a strip of the cushion pad having a width of 1 cm to 2 cm and a length of 30 cm to 40 cm, the strip of the cushion pad including a plurality of individual block portions, each of the plurality of the individual block portions having a width of 1 cm to 2 cm and a length of 1 cm to 2 cm;
holding the strip of the cushion pad by a hand of a user to apply the strip of the cushion pad to the surface of the automotive component assembly; and
attaching, by a thump of the user, each of the plurality of the individual block portions onto the surface of the automotive component assembly while concurrently or successively removing the paper film by an index finger of the user.

2. The method of claim 1, wherein the step of preparing the strip of the cushion pad comprises:
cutting a sheet of the cushion pad into a plurality of reduced sheet sections, each of the plurality of the reduced sheet sections having a width of 5 cm to 20 cm, a length of 20 cm to 70 cm, and a thickness of 0.2 cm to 1 cm;
preparing a die and a press and pressing each of the plurality of the reduced sheet sections on the die to form the plurality of the individual block portions by cutting only the non-woven fabric layer and the adhesive layer without cutting the paper film; and
cutting each of the plurality of the reduced cushion sheet sections into a plurality of the strips of the cushion pad, each of the plurality of the strips of the cushion pad having a vertically or horizontally elongated shape.
